(19) United States
(12) Patent Application Publication
(10) Pub. No.: US 2002/0067273 A1
(43) Pub. Date: Jun. 6, 2002

(54) Patient monitoring system

(75) Inventors: Marvin Baldwin Jaques, Lincoln, NE (US); Eric T. Risch, Omaha, NE (US); Jesse Lee Preuss, Lincoln, NE (US)

Correspondence Address: VINCENT L. CARNEY LAW OFFICE, P.O. BOX 80836, LINCOLN, NE, 68501-0836, US

(73) Assignee: Senior Technologies, Inc., Lincoln, NE

(21) Appl. No.: 09/952,011

(22) Filed: Sep. 11, 2001

Related U.S. Application Data
(63) Continuation-in-part of application No. 09/746,294, filed on Dec. 21, 2000.
Application No. 09/746,294 is a continuation-in-part of application No. 09/151,020, filed on Sep. 10, 1998.

(51) Int. Cl. G08B 23/00

(52) U.S. Cl. 340/573.4; 340/573.1

(57) ABSTRACT

To monitor a patient, a pressure sensor is placed under the patient. The pressure pad includes a normally open switch having first and second contacts. Pressure on the pad over a preset amount arms the switch and release of the pressure causes an alarm and/or a message to be announced. The closing of the first and second contacts requires bending one of the first and second contacts over a spacing means, wherein the spacing means includes at least one spacing member that is at least one-eighth inch in height between the first and second contacts. In this manner, the contacts are held apart until the resilient spacing member is forced shut. The pressure pad is low cost and can be disposable.

### RELATED CASES

This application is a continuation-in-part application of U.S. parent application Ser. No. 09/746,294 filed Dec. 21, 2000, by inventors, Kristin Robert Stroda, Jesse Lee Preuss and Marvin Baldwin Jaques, which is a continuation-in-part application of Ser. No. 09/151,020 filed Sep. 10, 1998, by Kristin Robert Stroda, now U.S. Pat. No. 6,166,644, for the invention entitled PATIENT MONITORING SYSTEM.

### BACKGROUND OF THE INVENTION

This invention relates to patient monitoring systems in which the movement or location of a patient is determined by one or more sensors at least one of which is a pressure sensitive sensor.

In some systems of this type, the movement or location of a patient is determined by any of a plurality of redundant or cooperating sensors. When one or more of the sensors indicates the existence of a problem concerning the patient, the patient monitoring system provides an alarm or a warning. In other systems, a single sensor detects an unauthorized location, movement or position of the patient and provides an alarm.

In one class of these patient monitoring systems, a sensor indicates the departure of a patient from his or her expected position and the system responds by providing an alarm. In one such system, a cord or other fixed length member has a fastener on one end and an activator on the other end and the activator is connected to a monitoring housing so that if the fastener moves beyond the fixed length, the monitoring housing is activated. The fastener is connected to a patient such as to the clothing of a patient by a clip so that if the patient moves beyond the fixed distance such as by slumping from a wheelchair onto the floor or moving from a bed the monitoring housing provides an alarm.

In a prior art monitoring system of this type, the end of the cord having the activator opposite to the fastener is loosely fitted into the monitoring housing so that when the patient moves away from the monitoring housing a distance greater than the length of the cord, the activator is pulled free. When the activator is pulled free from the monitoring housing, an alarm is given. Prior art systems of this type are disclosed in U.S. Pat. Nos. 4,577,185; 4,858,622; and 4,583,084 and systems of this type are on sale under the trademark, TABS, by Wanderguard, Inc., a division of Senior Technologies, Inc., located at 1620 North 20^{th} Street, P.O. Box 80238, Lincoln, Nebr. 68503.

This type of prior art patient monitoring system has several disadvantages, such as for example: (1) from time to time the fastener falls loose from the patient or is removed by the patient so that the system fails; (2) the patient may become entangled in bedding or the like or fall from the bed or chair or partly fall at a distance that does not pull the cord free; and (3) the cord may break or be cut.

In another class of patient monitoring systems, the patient in a bed or a wheelchair rests on or near a pressure pad. Changes in pressure on that pad cause a signal indicating that the patient is moving in a manner that indicates some type of problem such as, for example, leaning, falling from or slumping in or from a chair or bed. In a prior art monitoring system of this type, a manual switch is activated by an attendant or patient when the patient is in place to initiate the monitoring system and inactivated when the patient leaves in an ordinary non-troublesome manner. One such prior art system is disclosed in U.S. Pat. No. 4,907,845.

This type of prior art monitoring system has several disadvantages such as for example: (1) the switch may be accidentally thrown or thrown by a patient intending to move but for whom it is undesirable to move unattended because of confusion of the patient or illness to the extent that the patient does not appreciate; (2) the pad may be defeated by folding or placing a weight on it; and (3) some of the pressure pads are expensive to purchase and maintain.

It is also known for patient monitoring systems to include at least two sensors that cooperate for increased reliability in detecting a patient's movement. One such system is disclosed in U.S. Pat. No. 6,166,644, the disclosure of which is incorporated herein by reference. In this system, a pressure pad and another type of sensor are connected to the same alarming system to cooperate together.

Some prior art pressure pads are relatively expensive. In the prior art, the pressure pads are intended to be used for an extended period of time and may be used in connection with several patients. This type of pressure pad and method of use has several disadvantages such as: (1) it is subject to cross contamination in some cases, or in the alternative, requires relatively expensive pads to be discarded and new pads used when the patient is discharged from the facility; and (2) the battery must be checked and replaced to avoid an accidently inoperative system from being used.

### SUMMARY OF THE INVENTION

Accordingly, it is an object of the invention to provide a novel patient monitoring system.

It is a still further object of the invention to provide a novel pressure pad sensor that can be used in conjunction with other sensors to monitor a patient.

It is a still further object of the invention to provide a novel disposable pressure sensor for monitoring patients.

It is a still further object of the invention to provide a novel pressure sensor for monitoring patients that is both inexpensive and reliable.

In accordance with the above and further objects of the invention, a novel patient monitoring system is provided with one or more sensing modalities that alone or in cooperation with each other offer greater reliability. A novel disposable sensor is also provided that may be used in the novel patient monitoring system or alone. In this system of monitoring patients, an alarm or instructions to the patient are given when the patient assumes a dangerous position. The alarm signal is provided to the caretaker, such as at a nurses' station, and a voice message is announced in the vicinity of the patient when the patient assumes the dangerous position. The sensor may be armed by the application of weight to it and a signal may be provided to a caretaker when the weight is removed or another sensor detects an alarm condition, such as motion beyond a predetermined distance.

One unexpected problem with the design of inexpensive pressure pads has been the tendency of the pressure pad to be affected in its performance by being activated under a patient for a long time such as several days. If weight is placed upon some of them for a long time they will be delayed in responding when the weight is removed. This behavior is unpredictable as to the time required to recover and may require as much as 20 minutes.

The patient monitoring system of this invention has several advantages, such as for example: (1) it provides redundancy so that if one alarm fails the other may succeed to provide a warning alarm; (2) it permits the selection of one or more sensing conditions and combinations of different types of sensors, such as one that locates the distance that the patient has moved, and another that indicates that the patient has lifted himself or herself off of a pressure pad or has swung his or her legs over the edge of a bed or applied a substantial amount of his or her-weight to a support for lifting his or herself from a bed or wheelchair; (3) it can detect distress conditions that might otherwise be missed, such as for example a cord indicating a patient is leaving the bed or wheelchair or has fallen from it and a release-of-pressure sensor that indicates the patient may be thrashing about within the length of the cord or dangling from the bed or chair without exceeding the length of the cord; (4) it is difficult for the patient to defeat; (5) it is relatively flexible in the condition or conditions to be sensed and the nature of the alarm or alarms, or the warnings or messages to the patient, or the sequence of the alarms and messages and the location or locations of the alarm with respect to the caretaker of the patient; and (6) an inexpensive disposable pressure pad may be used to permit disposal after each patient and the use of a new pressure pad.

### SUMMARY OF THE DRAWINGS

The above noted and other features of the invention will be better understood from the following detailed description when considered in connection with the accompanying drawings, in which:

FIG. 1 is a simplified perspective view of an embodiment of the invention;

FIG. 2 is a block diagram of a patient monitoring system in accordance with the invention;

FIG. 3 is a fragmentary, simplified perspective view showing a manner in which the fastener, a cord and pressure pad are used to monitor a patient;

FIG. 4 is a simplified, perspective, fragmentary view illustrating the use of the patient monitoring system in connection with a bed;

FIG. 5 is a simplified partly perspective and partly schematic view of a portion of the embodiment of FIG. 1;

FIG. 6 is a block diagram of the control system for an embodiment of the invention;

FIG. 7 is a flow diagram of the program for determining an alarm condition using a pressure pad;

FIG. 8 is a schematic block diagram of a threshold circuit for the pressure pad;

FIG. 9 is a fragmentary perspective of a disposable pressure pad positioned on a bed to monitor patients in accordance with an embodiment of the invention;

FIG. 10 a fragmentary perspective view of a disposable pressure pad in accordance with an embodiment of the invention;

FIG. 11 is a schematic circuit diagram of a control unit used in an embodiment of a pressure pad;

FIG. 12 is a fragmentary perspective view of a portion of the pressure pad of FIG. 10;

FIG. 13 is an exploded perspective view of another embodiment of a pressure pad;

FIG. 14 is a perspective view of the embodiment of FIG. 13;

FIG. 15 is a simplified exploded view of still another embodiment of a pressure pad;

FIG. 16 is a simplified exploded perspective view of a portion of the embodiment of FIG. 15; and

FIG. 17 is a simplified schematic diagram of a portion of the embodiment of FIGS. 15 and 16.

### DETAILED DESCRIPTION

In FIG. 1, there is shown a simplified perspective view of a patient monitoring system 10 having a low-cost pressure pad 11, a cord 60 and a housing 13. The low-cost pressure pad 11 may be used for any purpose that pressure pads are used for, such as a bed pad or chair pad. A microprocessor (not shown in FIG. 1) within the housing 13 is electrically connected to the low-cost pressure pad 1 1 (first sensor) to cooperate with it and receive a signal when pressure is applied to the pad or released from the pad. The cord switch 34 (second sensor) includes a clip such as a badge or alligator clip 12, a cord 60, and a magnetic shunt 63 adapted to fit into a slot 67 in the housing 13. The clip such as a badge or alligator clip 12 is on one end of the cord 60 and the shunt 63 is on the other end of the cord 60.

The alligator clip or other connector 12 is fastened to the clothing of the patient and the magnetic shunt 63 is put into the slot 67. When the shunt 63 is removed, such as by the person moving a distance greater than the length of the cord 60, an alarm and/or voice message is sounded. Similarly, when pressure is placed on the low-cost pressure pad 11, a flag is set in the microprocessor so that when the patient releases the pressure, such as by getting up from the seat of the wheelchair or sitting up if on a bed, the microprocessor receives a signal resulting in an alarm or voice message and alarm.

To establish the electrical connections between the low-cost pressure pads and microprocessor or to pulse forming equipment or threshold equipment for processing signals for input to the microprocessor within the housing 13, the low-cost pressure pad 11 is connected by an electrical conductor 65 to the conductor 30 through an input circuit or interface 15 for adjusting the signal to the microprocessor, if necessary. The input circuit or interface 15 for the microprocessor may be incorporated within the housing 13 and its role is to develop a signal for the microprocessor when pressure is applied on the low-cost pressure pad 11, which in the preferred embodiment is a pad that reduces resistance when pressure is placed upon it. Other types of pressure pads are known in the art and any of them may be used but some of them would not require the input circuit or interface 15 but would generate their own signal.

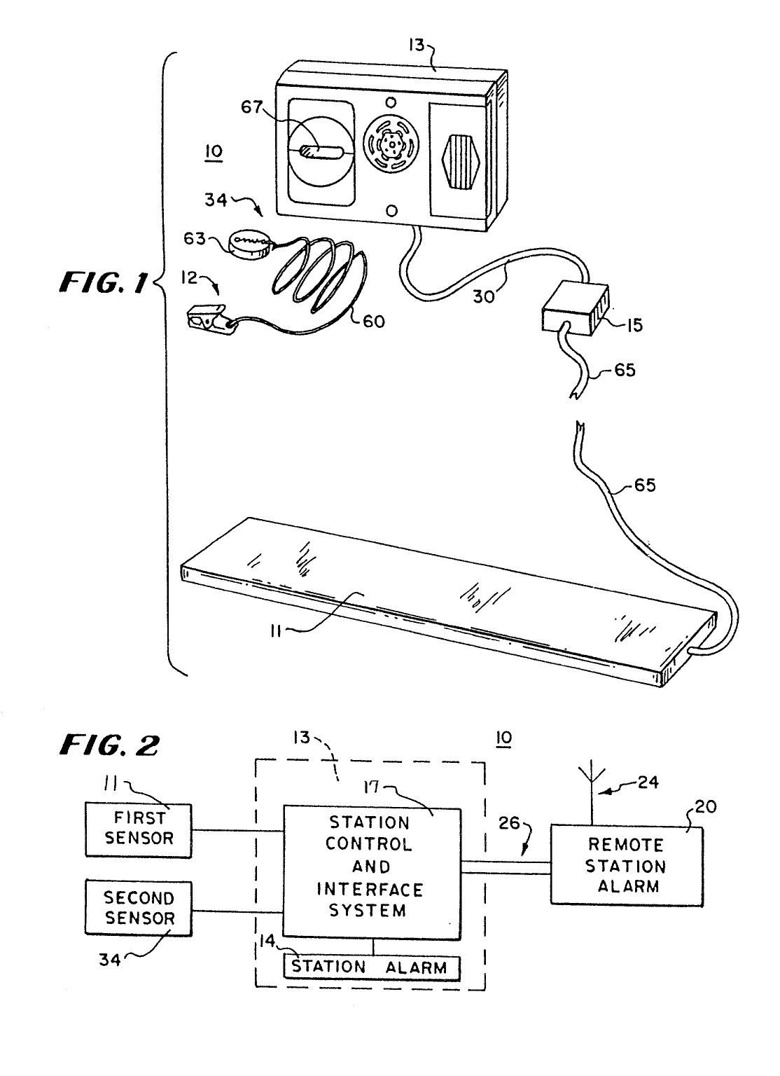

In FIG. 2, there is shown a block diagram of a patient monitoring system 10 having a first sensor 11, a second sensor 34, the patient station monitoring housing 13, a station alarm system 14, a station control and interface system 17, and a remote station alarm 20. The patient station monitoring housing 13 may include a voice record system in the manner disclosed in U.S. Pat. No. 5,494,046 for providing verbal instructions to a patient under certain sensed conditions. As in the case of the system described in U.S. Pat. No. 5,494,046, the disclosure of which is incorporated herein for reference, an alarm is given at the station with the patient and/or a nurses' station before a voice carries a message to the patient so that immediately upon the sensing of an alarm condition, the attendants receive notification and can proceed to the aid of the patient.

In the preferred embodiment, the second sensor 34 is a clip such as a badge or alligator clip 12 attached to a cord which moves an object in juxtaposition with the housing 13, such as a magnetic shunt that can be removed or a magnet that activates a reed switch, either placed inside or outside of the station alarm system 14 and the housing 13 or any other type of sensor, many of which are described in U.S. Pat. No. 4,494,046, such as photocell sensors that sense the removal of an object from the housing 13 by uncovering a light path or a mechanical device or any of many sensing devices that may sense the removal of an object from the interior of the housing 13 or the surface of the housing 13. Because the second sensor develops signals with a different criteria, it may be used to reset the pad. For example, the pad sensor may be reset by removing and reinserting the magnetic shunt 63 into the opening 67, rather than using pressure to both reset after a signal and to arm the sensor.

The station alarm 14 may include a lamp or a buzzer or the like and the remote station alarm 20 may be connected by wires 26 to receive an alarm such as at a remote location such as a nurses' station or may have an antenna 24 which receives a signal from the station alarm 20 or transmits a signal to other stations so as to provide an alarm at those stations. The alarms at the remote stations may also be any type of indicator such as a lamp, a buzzing sound, a ringing sound, a horn-like sound, or a voice.

While in the embodiment of FIG. 2 alarms are provided before the message is played both near the patient and at a remote location, the alarm nearby from the station alarm 14 may be omitted and the signal transmitted directly to the remote station alarm 20 or the message may be played with either or both the station alarm 14 and remote station alarm 20 or before either or both alarms. The voice system may be any standard commercial arrangement such as are now commonly used to play a fixed message. In the preferred embodiment, the voice system is a single chip, voice record/playback device Model ISD14XX sold under the trademark, DAST, by Information Storage Devices, Inc., 2841 Junction Avenue, Suite 204, San Jose, Calif. 95134.

The first sensor 11 is a low-cost reliable pressure pad designed to avoid excessive delay in opening after it has been closed by the weight of a patient for a length of time. It includes a resilient element that separates the conductive material in the low-cost pressure pad 11 of a size and composition so as to not cause a delay in opening after being held closed by a compressing weight for a reasonable period of time.

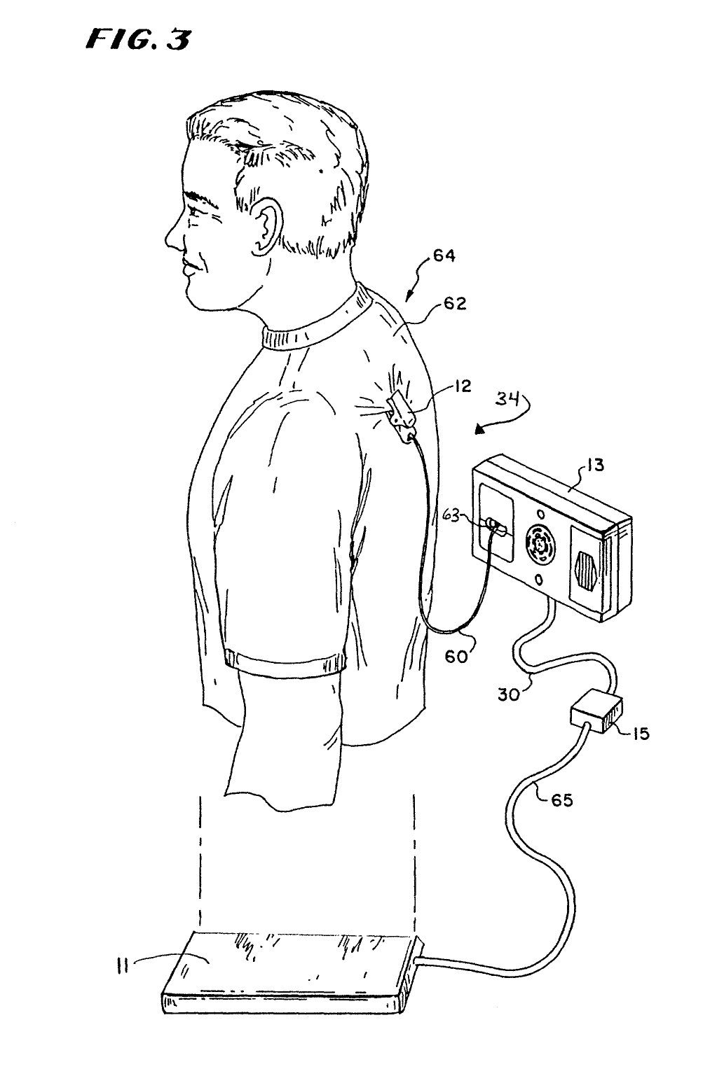

In FIG. 3, there is shown a fragmentary, simplified perspective view of a patient 64, the housing 13, the second sensor 34, the low-cost pressure pad 11 and the input circuit or interface 15. The patient 64 is wearing a garment 62 and is connected to the housing 13 by a clip, such as for example, an alligator clip or badge clip or other connector 12 fastened to the garment 62 and connected by at least one length of cord 60 to the housing 13 at the patient station, which alligator clip 12 and cord 60 together with components in the housing 13 to be described hereinafter, constitute the second sensor 34 (FIG. 2). In one embodiment, the clip such as a badge or alligator clip 12 is fastened by a first length of cord 60 to a switch member (not shown in FIG. 3) that may be pulled from its position in the housing 13 to signal an alarm easier than the alligator clip or other fastener 12 is freed from the garment 62. The low-cost pressure pad 11 is intended to be on the seat of a wheelchair or within a bed or other monitored location to provide a signal if the patient 64 leaves the monitored location.

The length of cord 60 should be selected for the use but should be within a range of five inches to five feet and preferably within a range of ten inches to twenty-four inches for a chair and still more preferably fifteen or eighteen inches for a chair. It should be preferably within a range of two feet to three feet for a bed and still more preferably thirty inches. The alarm switch may be of any type, such as for example the switch disclosed in U.S. Pat. No. 4,160,972, the disclosure of which is incorporated herein by reference, for embodiments in which the alarm is activated when the switch is opened. To activate an alarm when the switch is closed rather than when opened, a source of power in series with the alarm and switch may be used. Moreover, a voice processor 90 (FIG. 6) within the housing 13 may be used with other types of systems such as that disclosed in U.S. Pat. No. 4,577,185, the disclosure of which is incorporated by reference herein, to provide an alarm when the length of cord 60 is pulled free from the housing 13. Thus, the cord 60 may pull a ferromagnetic member away from a reed switch or may pull a mechanical switch closed or open or may move an opaque object from or into a location between a light source and a photocell to change the state of a switch and thus activate a voice recording and one or more alarms. The alarms 14 and 20 (FIG. 2) may be audible or visual or both.

With this arrangement, if the patient 64 were to move further away from the housing 13, such as by falling from a chair or leaving a bed, the cord 60 would stretch and pull the magnetic shunt 63 or other member free from the slot 67 (FIG. 1), closing a circuit in the housing 13 to activate the alarm and/or voice recording. Moreover, if pressure were released on the pressure pad 11 a signal would be given to provide an alarm.

The alligator clip or other connector 12 is generally fastened to the torso of a patient, such as on a shirt or the top part of a hospital gown or the like in the vicinity of the shoulders, and the cord 60 is sized in accordance with the location of the monitoring apparatus. For example, in a wheelchair the cord 60 is generally eighteen inches long, and in a bed setting, it is generally 30 inches long. It should be no shorter than five inches and no longer than five feet in length. The housing 13 is generally fastened to a nearby support.

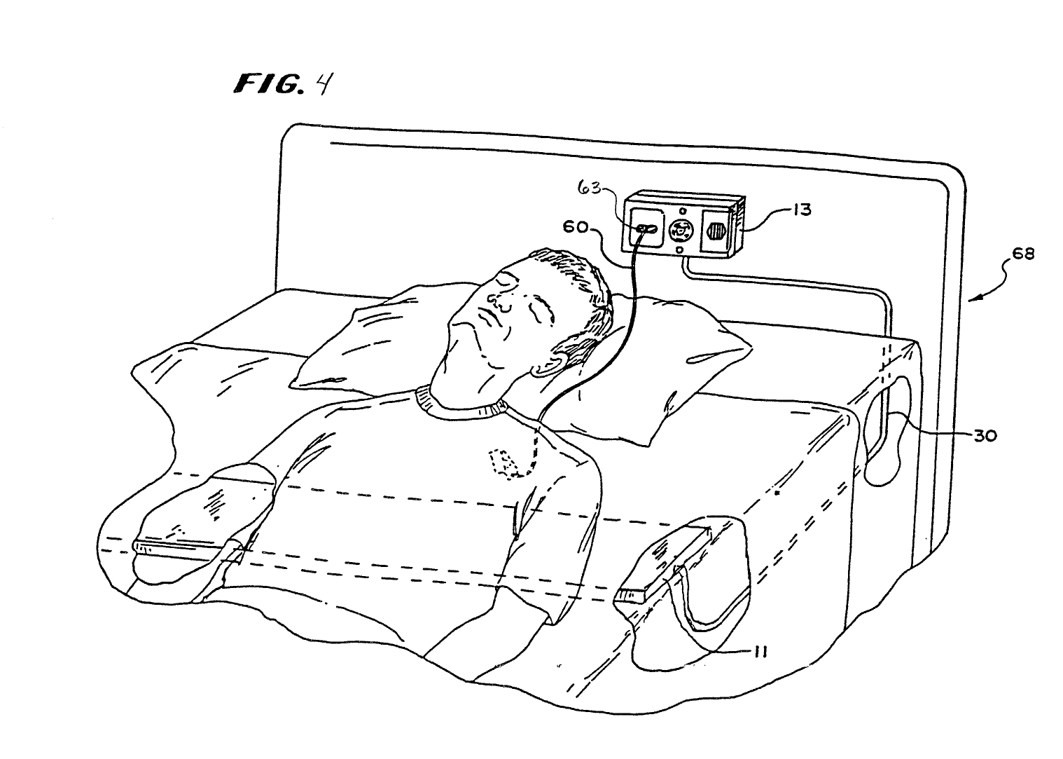

In FIG. 4, there is shown a simplified, perspective, fragmentary view of a bed 68 equipped with a patient station monitoring housing 13 mounted to the headboard so that a clip such as a badge or alligator clip 12 (FIGS. 1 and 3) can be fastened to a patient. The cord 60 has a sufficient length so that if the patient falls from the bed 68 or attempts to leave, the cord 60 will cause either the magnetic shunt 63 to be pulled from the housing 13 or the low-cost pressure pad 11 to receive less weight and generate a signal. The low-cost pressure pad 11 is preferably placed under the patient's buttocks but may be placed anywhere else that will generate weight related signals, such as under the shoulders of the patient. In either case, a voice message may be played requesting the patient to remain in the bed or instructions may be given to the patient and/or an alarm may be transmitted to a caretaker who can attend to the matter. In the preferred embodiment, the cord 60 is thirty inches long.

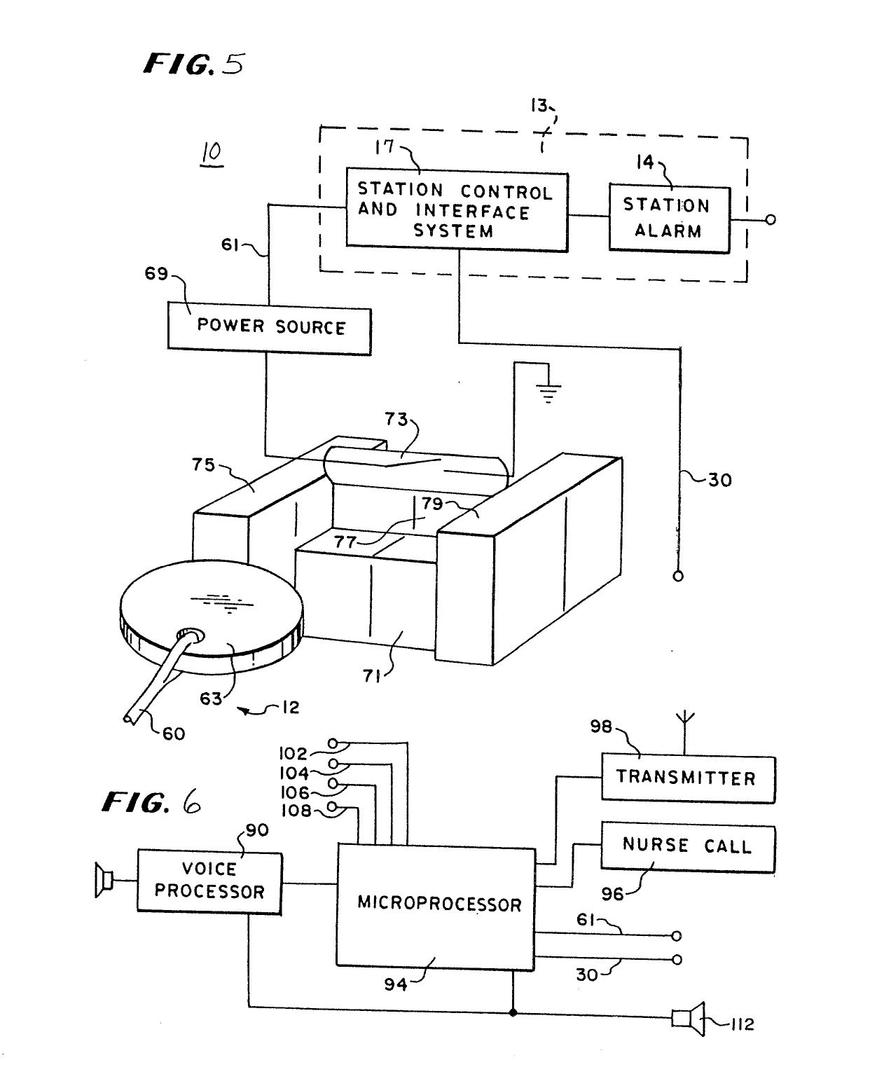

In FIG. 5, there is shown a simplified, fragmentary, partly-perspective and partly-schematic view of one embodiment of the patient monitoring system 10 having the first length of the cord 60, the station alarm 14, the pressure pad sensor conductor 30 connected so that when the magnetic shunt 63 is pulled free from the housing 13, the reed switch 73 closes a circuit with the power supply 69 to send a signal through the conductor 61 to the station control and interface system 17 to provide an alarm signal and when the weight of the pressure-pad is released, a signal is sent through conductor 30 through the station control and interface system 17 to provide an alarm. The station control and interface system 17 performs the “OR” function within the microprocessor 94 (FIG. 6) or by a separate “OR” gate before the microprocessor 94.

In the embodiment of FIG. 5, the housing 13 includes a permanent magnet or an energized electromagnet 71, a reed switch 73, and ferromagnetic path members 75, 77 and 79. The ferromagnetic path members 75, 77 and 79 form a closed ferromagnetic circuit with the magnet 71 to close the reed switch 73 and prevent an alarm. This ferromagnetic circuit maintains the normally open reed switch 73 in its closed position. When the magnetic shunt 63 is removed and the reed switch 73 opens, an alarm is given. Of course, a normally closed switch can be used by reversing other circuit elements and other sensors can be used. With this arrangement, when the magnetic shunt 63 is pulled free, a signal is transmitted to the station control and interface system 17 and the station alarm 14 to initiate the voice message and/or alarm from the voice processor 90 (FIG. 6) of the housing 13 (FIGS. 1, 3 and 4) and the remote station alarm 20 (FIG. 2), as explained in connection with FIG. 2.

FIG. 6 is a block diagram of the control system for an embodiment of the invention and has as its principle parts a microprocessor 94, a transmitter 98, an alarm speaker 112, a nurse call station 96 and a voice processor 90. The microprocessor 94 is a type PIC16C54 Microcontroller sold by Microchip Technology, Inc. of Arizona. It is an 18-pin microprocessor having an input 102 for tone select, an input 104 for another tone select, an input 106 for local alert and an input 108 for local voice to set the microprocessor 94.

With this arrangement, when an input signal is received from the conductor 30, a flag is set in the microprocessor 94. When a signal is received indicating a release of the pressure, the microprocessor 94 transmits an alarm signal to the nurse call station 96, the transmitter 98 and the alarm speaker 112 within two and one-half seconds unless the pressure is again applied to the sensing pad. If set for that purpose, a signal may be sent to the voice processor 90. This provides the warning to the patient. Similarly, a signal from the station control and interface system 17 (FIG. 5) or similar component in other circuit arrangements or from other sensors indicating that a sensor has been activated, such as by pulling the magnetic shunt 63 free initiates an alarm signal.

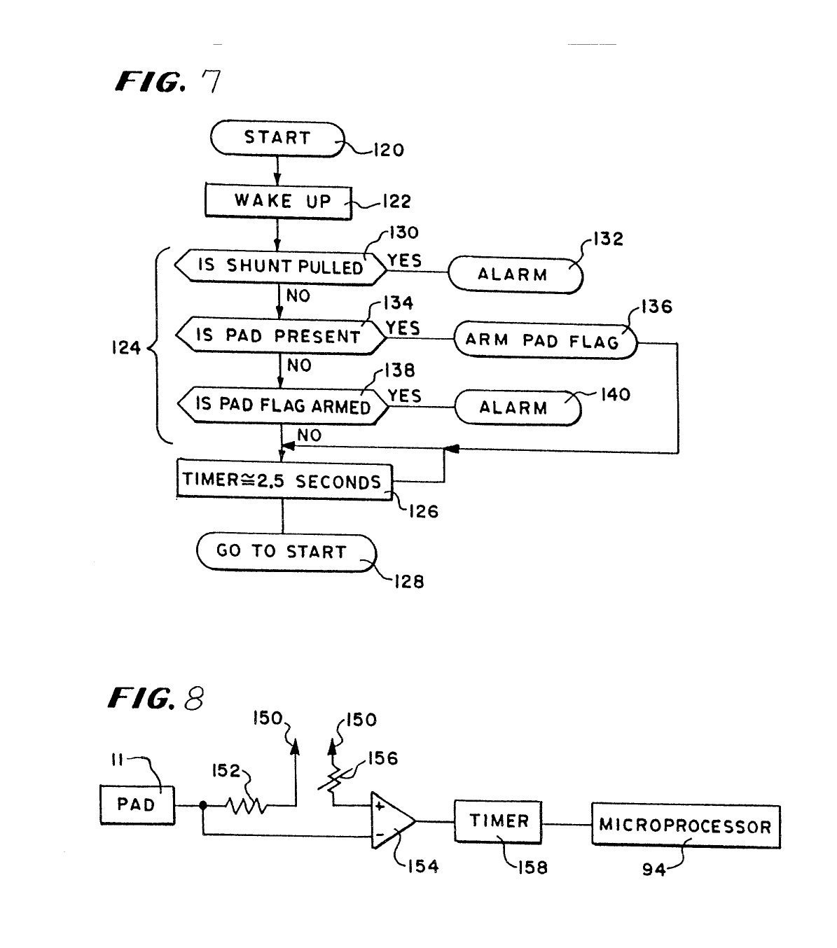

In FIG. 7, there is shown a flow diagram of a program utilizable in the microprocessor 94 (FIG. 6) to determine an alarm condition using a low-cost pressure pad 11, which program includes a start step 120, a wake-up or power starting and initializing step 122, an alarm condition detecting step 124, a timer step 126 and a go to start step 128. With this arrangement, the microprocessor 94 (FIG. 6) is initialized such as at the step 122 and determines if there is an alarm condition caused by the shunt 63 being removed or the low-cost pressure pad 11 being armed and removed, determines if there is an alarm condition on the pad 11, if it lasts for approximately 2.5 seconds and returns to start step 120 as indicated at step 128.

The alarm condition detecting step 124 includes the steps of determining if the shunt 63 is pulled at step 130, providing an alarm signal as shown at 132 if it has been pulled, and if it has not been pulled, going to the decision step 134. The decision step 134 determines if the pad is present and if it is, the program proceeds to the arm the pad step 136 by applying a pressure pad flag if pressure has been applied to the low-cost pressure pad 11 to reduce resistance. If the pad is not present, then the program proceeds to the decision step 138 to determine if there is an armed pad flag, and if there is, then it proceeds to the step 140 to provide an alarm. If not, it proceeds to the timer step 126 and from there back to the start step 120 from the go to start step 128. If the armed pad flag 136 is set as a result of the low-cost pressure pad 11 being present and weight being upon it, then the program proceeds to the timer step 126 and from there back through steps 120, 122, 130, 134, 138 and alarm step 140. With this arrangement, an alarm is provided if the shunt 63 is pulled or if the flag is armed and weight is removed for approximately 2.5 seconds. While 2.5 seconds is the preferred time, the time can be set in the microprocessor to any value but should be to a value less than 15 seconds.

In FIG. 8, there is shown a schematic block diagram of the microprocessor circuitry 94 connected to the low-cost pressure pad 11. The pad 11 is energized by a source of voltage 150 applied to the low-cost pressure pad 11 through a resistor 152. A comparator 154 has its noninverting input terminal energized by the voltage source 150 through an adjustable resistor 156 that determines a threshold value for the pad 11 that can be set to accommodate the weight and size of a person on the pad 11. The pad 11 provides the signal as determined by the voltage source 150 and controlled by the resistance of the low-cost pressure pad 11 to the inverting terminal of the comparator 154 to initiate a timer 158, which may be within the microprocessor 94 or separate from the microprocessor 94. If this condition as determined by the comparator 154 lasts for approximately 2.5 seconds in the preferred embodiment, then the microprocessor 94 provides an alarm signal, but if the threshold from the low-cost pressure pad 11 as applied to the comparator 154 falls at the noninverting input terminal, then the timer 158 is reset and no alarm is given.

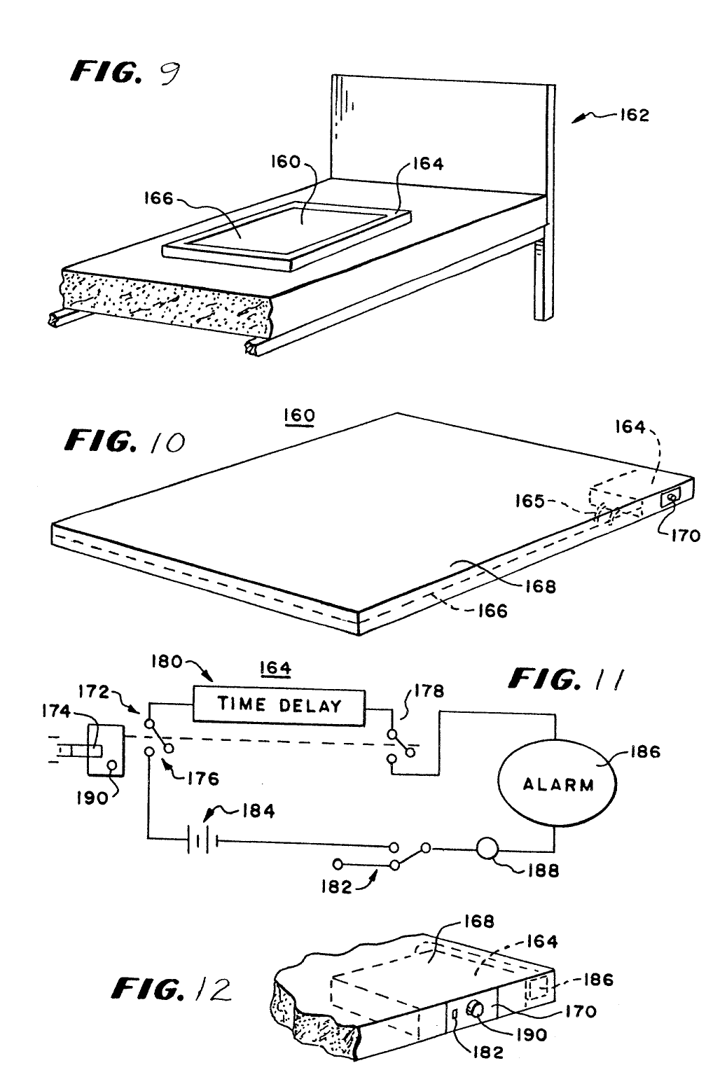

In FIG. 9, there is shown another embodiment 160 of a pressure sensing pad resting on a bed 162 having a control unit 164, a pressure sensor 166 and an enclosing case 168 (FIG. 10). The case 168 is made of a flexible or partly flexible material that feels good to the touch such as plastic or partly plastic and partly cloth or any other materials. The control unit 164 is located in a pocket within the case 168 so that a control surface is exposed and available for setting. Otherwise, the case 168 entirely encompasses the pressure sensor 166 and seals the pressure sensor against most moisture. The pressure sensing pad 160 is intended to be disposable so that it may be used with one patient and then disposed of.

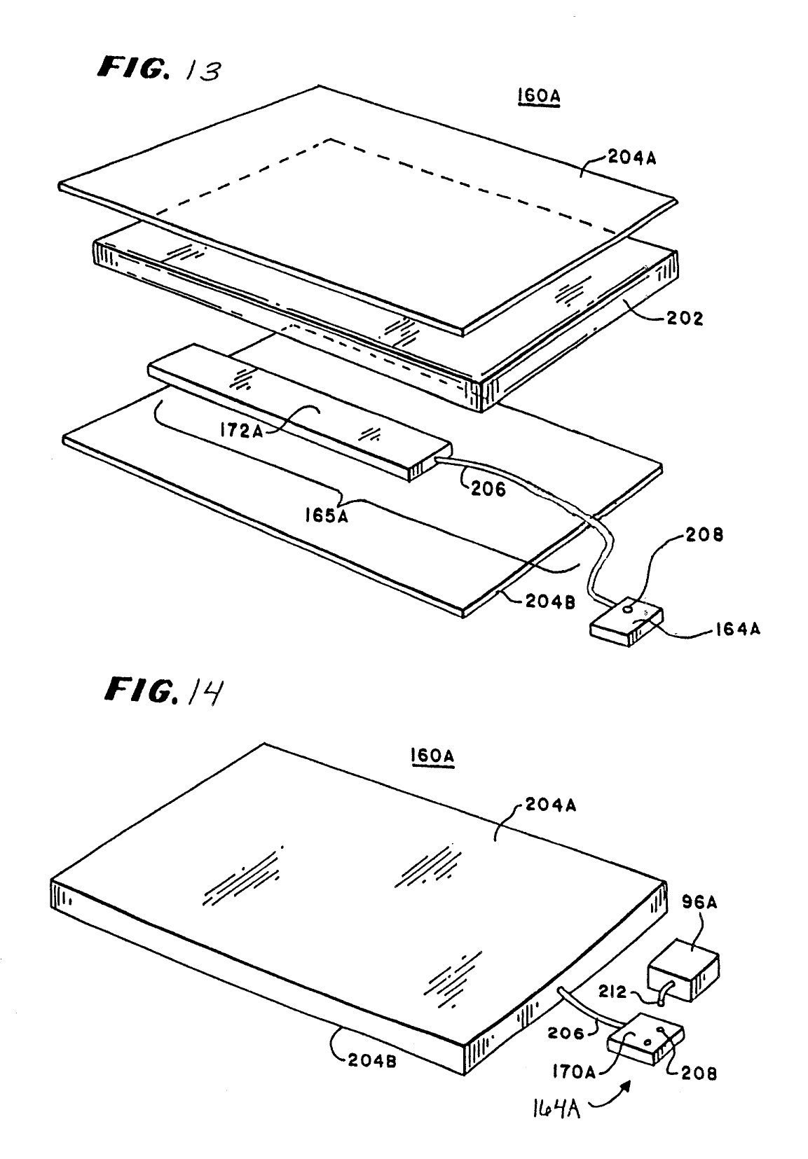

In FIG. 10, there is shown a fragmentary perspective view of one embodiment of the disposable pressure sensing pad 160 showing the enclosing case 168, the control unit 164 and a pressure sensor 166. In this embodiment, the pressure sensor 166 is a gel pad of the type used for patients having sensitive areas to rest upon, with one or more tubes 165 communicating with the interior of the pressure sensor 166 and with the pressure switch in the control unit 164. The enclosing case 168 is sealed around the control unit 164 leaving a control face 170 exposed to permit adjustment of the amount of pressure necessary to cause an alarm to be given by the pressure sensing pad 160. The pressure sensor 166 may remain enclosed and the amount of pressure that must be applied to it to activate it may be set by a bias adjustment manual dial 190 (FIG. 11). In other embodiments, the pressure may be preset at the factory and the pressure sensing pad sold calibrated to a certain pressure. If multiple gel pads are combined into one pressure sensing pad, then multiple tubes 165 must connect to a manifold and the manifold to the pressure switch in the control unit 164.

In FIG. 11, there is shown a simplified schematic circuit diagram of the control unit 164 having a double-pole, single-throw pressure-activated switch 172, a time delay circuit 180, an audible alarm 186, an on/off switch 182, a battery 184, and a lamp 188. The double-pole, single-throw pressure-activated switch 172 has a first switch contact set 176 and second switch contact set 178 and an actuator plunger 174. The actuator plunger 174 communicates with a pressure sensor so as to be held open when pressure beyond a preset value is placed on the pressure sensor. This switch 172 also opens a second switch contact set 178 in circuit with the time delay circuit 180 and the switch contact set 176. This switch arrangement is in circuit with the audible alarm 186, the lamp 188, a single-pole double throw on/off switch 182, and the battery 184 so that when the switch 172 is closed, the normally open switch contact sets 176 and 178 are closed by pressure to form a circuit that includes the battery 184, the audible alarm 186 and the lamp 188. The on/off switch 182 is a third switch that may open the circuit.

When the on/off switch 182 is closed and there is no pressure upon the pressure sensor, the circuit is completed through the normally closed switch contact sets 176 and 178, the time delay circuit 180, the alarm 186, the lamp 188, the on/off switch 182 and the battery 184 so that the lamp 188 is illuminated and the alarm 186 given. When pressure is applied to the pressure sensor beyond a preset amount as set by the bias adjustment manual dial 190, the circuit is broken, or if the circuit is turned off by the on/off switch 182, the circuit is broken. If the on/off switch 182 is closed and pressure is removed from the double-pole, single-throw pressure-activated switch 172, a signal is sent through the time delay circuit 180. If the switch 172 remains inactivated, the signal passes through the switch contact set 178 and the alarm 186 sounds and the lamp 188 is illuminated. However, if while the circuit signal is passing through the time delay circuit 180, pressure is again applied to the pressure sensor, then the switch contact set 178 is open and no alarm is given.

With this arrangement, if the pressure sensing pad 160 is placed on a wheelchair or a bed and energized by closing the on/off switch 182, the pressure will open the switch contact sets 176 and 178 so there will be no alarm. However, if the patient leaves the seat or the bed, the normally open switch contact sets 176 and 178 will close and if they remain closed after the time of the time delay circuit 180, the alarm 186 will sound and the lamp 188 will be illuminated unless the on/off switch 182 is open. The switch 172 includes an actuator plunger 174 which may be in physical contact with the interior of the pad and which is adjustable by the bias adjustment manual dial 190. This sensor may be similar to the sensor in U.S. Pat. No. 4,336,533.

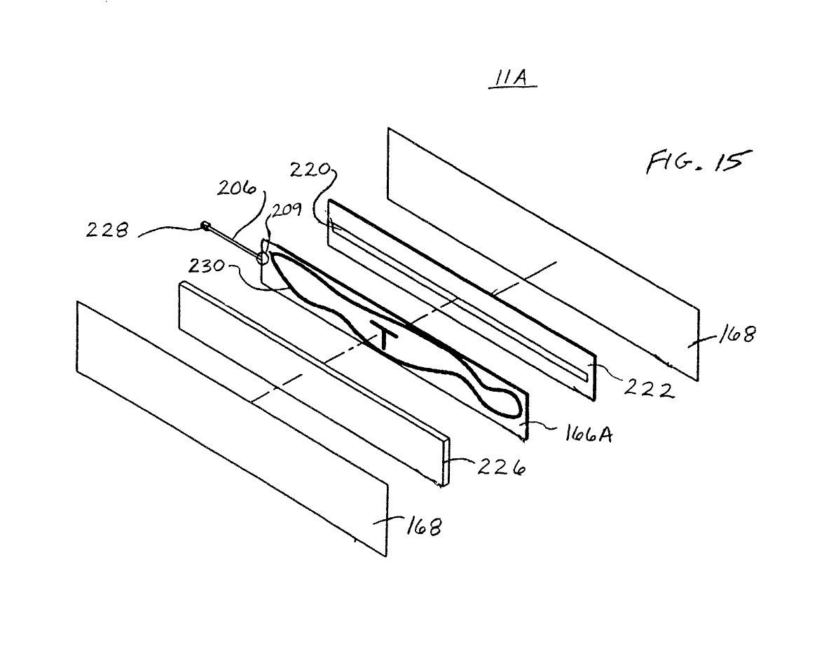

In FIG. 12, there is shown a fragmentary perspective view of the control unit 164 within the case 168, with the case 168 sealed to the control face 170 leaving exposed the lamp 188 (not shown in FIG. 12), the speaker of the alarm 186, the bias adjustment manual dial 190 and the on/off switch 182. With this arrangement, the activating pressure may be set to accommodate different weight patients by the bias adjustment manual dial 190. The on/off switch 182 is accessible to control the pressure sensing pad 160, and the lamp 188 (FIG. 11) and alarm 186 are easily seen and heard.

When a preset time period is near its end or a patient is discharged and it's desirable to dispose of the low-cost pressure pad and provide a new one for a new patient, the plastic casing may be torn to indicate that the disposable pad is to be discarded and may be discarded in whatever provision is made within the nursing home or hospital for discarding such used, disposable items. Thus, when a new patient is admitted, a new pad may be used with the patient and assigned to the patient so that there will be no cross contamination between patients. The pads have a preset life and if that life is exceeded, then the pad is changed and a new pad is assigned to that patient. When the patient is discharged, the pad is discarded.

While a gel pad of the type sold by Deka Medical, Inc., P.O. Box 2426, Columbus, MS 39704 under the trademark, Gel-Lite, is desirable, combined with the pressure switch such as that disclosed in U.S. Pat. No. 4,336,533, other types of pressure sensitive pads and switch mechanisms may be used. For example, the switch mechanism described above may be used and this pad may be incorporated as part of the multiple sensor configuration described in this application. Similarly, other pads may be utilized although because the pad is disposable, it is desirable that inexpensive types of sensing pads be used.

In FIG. 13, there is shown an embodiment of a disposable pressure sensing pad 160A having a commercial gel pad 202, a vinyl cover shown at 204A and 204B and a sensor 165A. The sensor 165A may be of the type disclosed in U.S. Pat. No. 5,990,799 issued Nov. 23, 1999, to Boon et al., having a pressure activating switch 172A, an electrical cord 206 and a control unit 164A containing an alarm and jack socket 208 for receiving a nurse call of the type sold by Senior Technologies, 1620 North 20^{th} Street, Lincoln, Nebr. 68503, under the trademark, Arial.

In FIG. 14, there is shown a perspective view of a disposable pressure sensing pad 160A completely assembled to be entirely covered by a vinyl cover 204A and 204B and having the cord 206 extending from it. The vinyl cover 204A and 204B may be a continuous vinyl pouch integrally formed to be sealed at one end or may be in sections sealed after the sensing pad has been positioned in place. The control unit 164A has a face 170A to indicate the condition of the battery, an alarm and a jack socket 208 for receiving a nurse call unit 96A containing a jack 212 to be inserted in the alarm and jack socket 208. With this arrangement, the pad 160A may be discarded after a patient is discharged or if it becomes soiled, saving the nurse call unit 96A and in some embodiments, the control unit 164A which may be connected to the cord 206 by means of an alarm and jack socket 208.

In FIG. 15, there is shown a simplified exploded view of an embodiment of a low-cost pressure pad 11A having a vinyl case 168, a foam pad 226, an embodiment of a pressure sensor or switch 166A and a stiffner 222. The vinyl case 168 is shown with just the top and the bottom sections but actually encloses the entire low-cost pressure pad 11A. Within the vinyl case 168 is the pressure sensor or switch 166A having the foam pad 226 above it and the stiffner 222 below it. The low-cost pressure pad 11A can be of any length, such as for example approximately two feet or longer depending on its application. It is intended to stretch across the distance being monitored. Similarly, it can have any width but in the preferred embodiment, the pressure pad for a bed is three and one-half inches wide and approximately an inch thick from top to bottom when there is no pressure placed on top of it.

To provide reasonable stiffness in use, the stiffner 222 is a plastic strip three-sixteenths of an inch thick, three and one-half inches wide and approximately two feet long in a two feet embodiment. However, any suitable stiff material can be used and the plastic strip is chosen mainly for economy. The stiffness is selected to compensate for different degrees of flexibility of the bed surface or other surface upon which the pad 11A may rest and the different weight that may be placed on it by different mattresses and patients. The pad should not so easily bend under pressure as to fail to impart sufficient pressure to activate the alarm when a patient is on it but should not be so stiff as to cause discomfort for the patient.

The foam pad 226 is for purposes of desensitizing the pressure pad from variations in the weight of a mattress and the weight of the patient or other weights that may be placed upon it. In some uses, the pressure pad has weight placed upon it other than that of a patient. These weights provide a biasing weight. For example, the pressure pad may be under a mattress. In this example, the mattress provides a biasing weight. There must be sufficient difference between the combined weight of the patient and the biasing weight to activate the pad when the patient is on the bed, but not to activate the pad by the biasing weight alone. The foam pad 226 takes up some of the pressure from weight placed on the pressure pad 11A and reduces the tendency to be activated by a heavier mattress without a patient. Instead it requires a greater difference in weight than the disparity between mattresses but not as great as the difference between any common mattress and the combined weight of a patient and the mattress. The foam pad 226 is preferably cut from any foam pad to be the appropriate length, such as two feet by three and one-half inches wide and one-half inch thick in the embodiment of FIG. 15.

To provide some friction between the pressure sensor or switch 166A and the stiffner 222, a strip of transfer tape 220 approximately one-half inch wide and shorter than the width of the stiffner 222 may be applied to the stiffner 222 to be between the stiffner 222 and the pressure sensor or switch 166A. This is optional but serves the purpose of holding the pressure sensor or switch 166A in position against the stiffner 222.

The pressure sensor or switch 166A is approximately three and one-half inches wide and stretches across approximately two feet in length in the case of the embodiment of a low-cost pressure pad 11A in FIG. 15. It has an adhesive foam 230 sprayed on one surface for better connection to the foam pad 226 and is electrically connected to the control box through the cord 206 and an N connector 228. A knot 209 is tied in the cord 206 about an opening in the pressure sensor or switch 166A so tension on the cord 206 is not transferred into the pressure sensor or switch 166A to pull against the connections between the conductors in the cord 206 and the conductive surfaces in the pressure sensor or switch 166A.

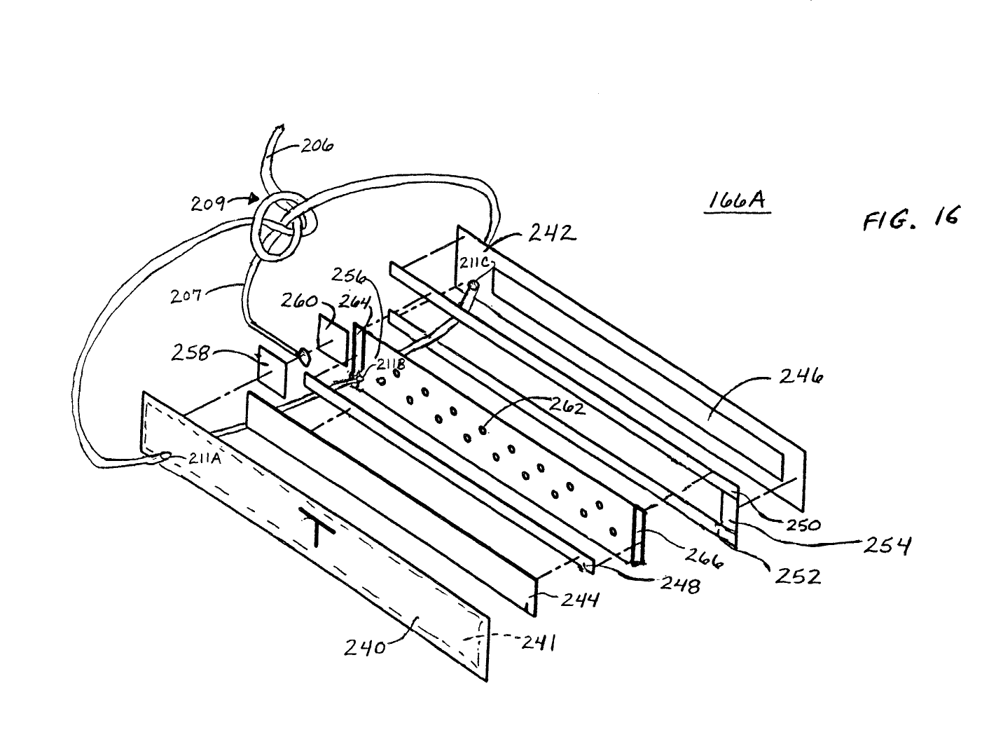

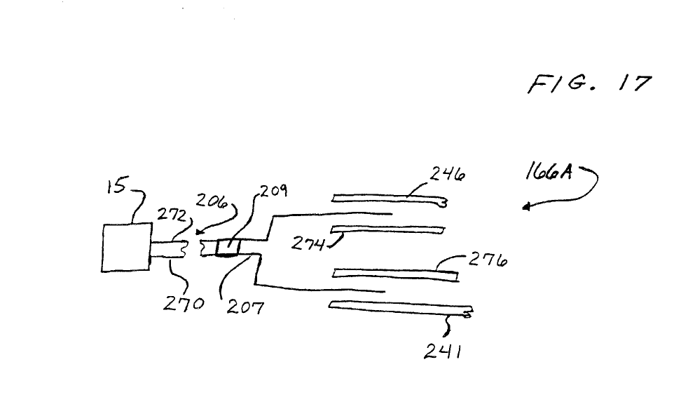

In FIG. 16, there is shown a simplified exploded perspective view of the pressure sensor or switch 166A having a top PCB strip 240 with a conductive surface 241 facing inwardly, a bottom PCB strip 242 with a conductive surface 246 facing inwardly toward the conductive surface 241, and a conductive foam pad 244 positioned adjacent to the conductive surface 241. The conductive foam pad 244 aids in making electrical contact between the conductive surface 241 and the conductive surface 246 by pressing into the apertures 262 when pressure is applied to the pressure sensor or switch 166A. The PCB strips 240 and 242 are backing for the contacts and are generally sized to conform to the sides of the thin elongated switch, which in the preferred embodiment are right, regular parallelepipeds having a length of twenty-four inches, a width of three and one-half inches and a thickness of approximately one-thirty seconds of an inch, although the dimensions are not critical except that they must be such as to form a flat member capable of receiving and registering the weight of the patient at a selected location. They form backing for the slightly smaller, but similarly shaped contacts 241 and 246 that are conductive members which may be either conductive ink on the backing strips or separate foil-like members or any other appropriate conductors.

Because this switch is a normally open switch, the contacts 241 and 246 are normally held apart by an aperture spacer 256 which is a plastic strip having a plurality of apertures 262. Its dimensions in the preferred embodiment are sized to space the contact surfaces 241 and 246 apart except under pressure and for that purpose in the preferred embodiment is 24 inches by three and one-half inches by approximately one-thirty seconds of an inch thick with apertures in the form of circles that are three-eighths of an inch in diameter extending between its flat rectangular surfaces to permit contact under pressure. In the preferred embodiment, there are two rows of such apertures, spaced evenly from each other on alternate sides of a central line between and parallel to the 24-inch sides of the parallelopiped shaped spacer with each row containing eight such apertures 262. However, any configuration that permits pressure between the top and bottom PCB strips 240 and 242 is sufficient including an elongated opening over the contact area. For frictional support, the three and one-half inch edges have thin strips of transfer tape near them extending between the long parallel edges such as shown at 264 and 266. Moreover, adhesive element 254 is also provided for the purpose of holding the parts of the pressure sensor or switch 166A together.

In the preferred embodiment, a plurality of apertures 262 are incorporated in the spacer 256 to form contact surfaces. To ensure contact, a conductive foam pad 244 is provided. The conductive foam pad 244 is a foam pad impregnated by conductive ink. It is in the preferred embodiment, 24 inches by three and one half inches by approximately 50 thousandths of an inch. It is sized so that under pressure it compresses in the apertures 262 of the plastic aperture spacer 256 to make electrical contact between the conductive surfaces 241 and 246.

To serve as a separating spring to force the contact surfaces 241 and 246 apart when pressure is removed, one or more spring members provide a response time sufficiently fast in opening and providing an alarm so as to not permit a disabled person to move sufficiently far as to be in danger and so as to quickly bring help, even after a prolonged time of the pressure sensor or switch 166A being closed by pressure. The spacing element in the preferred embodiment is the central rubber spacer 248 which is 20 inches long extending parallel to the long parallel edge of the conductive contact surfaces 241 and 246. In one embodiment, the spacer is three-fourths of an inch wide and 60 thousandths of an inch high. In another embodiment it is three-eighths of an inch wide and three-sixteenths of an inch high. It should be at least one-eighth of an inch high but not more than one and one-half inches high. If it is too high the switch may not close reliably under a patient's weight. The aperture spacer 256 may provide adequate contact at any of a number of openings. The minimum threshold resistance under some circumstances may require some distributed weight to cause adequate contact, but generally it does not. If the aperture spacer 256 is used, it should be at 20 thousands of an inch high but could be higher or lower. On the top surface, the plastic strips 250 and 252 are spaced near the edges as stationary spacers and connected at one side by the double-sided adhesive foam 254 as an independent spacer between the aperture spacer 256 and the conductive contact surface 246.

The spring elements were found to be necessary because without them or with only a small spacer, the delay in opening after a patient left the bed was excessive if the pressure sensor or switch 166A had been held closed for days. This result was surprising because if the pad were removed from under the mattress, the pressure switch would open properly, but if left under the mattress and only the patient left the bed after being on it for several days, the sensor would not be activated.

To provide a firm anchor for the cord 206, on each side of the cord a different one of foam tape members 258 and 260 are provided to anchor, in an insulated manner, the cord 206 so its conductors may be electrically connected respectively to the conductive contact surfaces 241 and 246 to form a complete closed circuit when the contacts 241 and 246 are brought together. A knot 209 is tied in the cord 206 by passing it through aligned openings 211A-211C and tying it at 209 so that the section 207 of the cord 206 is not pulled when the cord 206 is pulled. The section 207 is connected to the conductive surfaces 241 and 246 and the knot prevents them from being easily pulled free by tension on the cord 206.

In another embodiment, the aperture spacer 256 and conductive foam pad 244 are omitted and a special ink is used for the contacts 241 and 246. This ink decreases in resistance as the pressure on them increases so as to provide a signal dependent on weight. Thus, a change in the amplitude of the electrical signal is used to determine if the patient has left the pressure pad. The special ink is disclosed in U.S. Pat. Nos. 4,874,549; 4,745,301 and 4,749,878. Instead of printed material on the contact surfaces a single solid pad of the type disclosed in the above mentioned patents can be provided between the two conductive surfaces 241 and 246 to serve as a pressure responsive variable resistor.

In FIG. 17, there is shown a simplified schematic diagram illustrating the electrical connections between the input circuit or interface 15 that applies an electrical potential between two conductors 270 and 272 within the cord 206 and the conductive contact surfaces 241 and 246 (FIG. 16). As shown in this view, the conductors 270 and 272 have the insulation removed from them and are held by tape 274 and 276 respectively to the conductive contact surfaces 246 and 241 respectively.

With this arrangement, the aperture spacer 256 (FIG. 16) normally separates the conductive contact surfaces 241 and 246 apart so as to always provide a slight resistance and a slight separation between them unless compressed and when compressed to provide connection only through apertures 262 (FIG. 16). The spring spacer members, principally the central spacer 248, provides adequate quickness in moving the contacts 241 and 246 apart even after pressure has been placed on the pressure pad 11A for an extended period of time.

The patient monitoring system of this invention has several advantages, such as for example: (1) it provides redundancy so that if one alarm fails, the other may succeed to provide a warning alarm; (2) it permits the selection of one or more sensing conditions and combinations of different types of sensors, such as one that locates the distance that the patient has moved and another that indicates that the patient has lifted himself or herself off of a low-cost pressure pad or has swung his or her legs over the edge of a bed or has applied a substantial amount of his or her weight to a support for lifting his or herself from a bed or wheelchair; (3) it can detect distress conditions that might otherwise be missed, such as for example a cord indicating a patient is leaving the bed or wheelchair or has fallen from it and a release-of-pressure sensor that indicates the patient may be thrashing about within the length of the cord or dangling from the bed or chair without exceeding the length of the cord; (4) it is difficult for the patient to defeat; (5) it is relatively flexible in the conditions to be sensed, the nature of the alarm or alarms or the warnings or messages to be given, the sequence of the alarms and messages and the location or locations of the alarm with respect to the caretaker or the patient are selectable; (6) it is economical so that it may be entirely or partly disposed of between patients or if it becomes soiled; and (7) it can be connected to other units such as a nurse call system for increased flexibility of use.

Although a preferred embodiment of the invention has been described with some particularity, many modifications and variations of the preferred embodiment are possible within the light of the above teachings. Therefore, it is to be understood that, within the scope of the appended claims, the invention may be practiced other than as specifically described.

What is claimed is:

1. Apparatus for monitoring a patient, comprising:
a control housing mounted to a patient station;
a flexible member attached to the control housing;
said flexible member including a fastening means on one end for attaching to the patient and a switch on the other end;
a pressure pad located so that the pressure pad is under the patient;
the control housing including a means for providing an alarm signal when the fastening means or pressure pad are activated;
said pressure pad including a pressure sensor having first and second contacts and a spacing means for holding said first and second contacts open;
said spacing means including at least one spacing member that is at least one-eighth inch in height between the first and second contacts, whereby the contacts are held apart until the resilient spacing member is forced shut.

2. Apparatus for monitoring a patient in accordance with claim 1 in which said pressure pad is activated by removal of pressure and inactivated by application of pressure.

3. Apparatus in accordance with claim 1 in which said fastening means includes a spring means for biasing jaws in a closed position.

4. Apparatus for monitoring a patient, comprising:
a pressure pad for providing a signal indicating a pressure condition;
a control housing connected to and located adjacent to the pressure pad and responsive to the signal;
a casing at least partly encasing the control housing and the pressure pad;
said pressure pad including a pressure sensor having first and second contacts and a spacing means for holding said first and second contacts open;
said spacing means including at least one spacing member that is at least one-eighth inch in height between the first and second contacts, whereby the contacts are held apart until the resilient spacing member is forced shut.

5. Apparatus for monitoring a patient in accordance with claim 4 in which the pressure pad is activated by removal of pressure and inactivated by application of pressure.

6. Apparatus in accordance with claim 4 further including a recorded voice message sounding within hearing distance of the patient.

7. Apparatus in accordance with claim 4 wherein the pressure pad responds to pressure by reducing electrical resistance between a first point and a second point, said apparatus including a switch armed upon the reduction of electrical resistance and an alarm for providing the alarm when the switch has been armed and the electrical resistance is under a predetermined resistance threshold for more than 1 second, wherein a movement of the patient from the pressure pad triggers the alarm.

8. A patient monitoring system according to claim 4 in which the alarm provides the alarm when the switch has been armed and electrical resistance is under the predetermined resistance threshold for a time between 2 seconds and 3 seconds in duration.

9. Apparatus for monitoring a patient, comprising:
a pressure pad for providing a signal indicating a pressure condition;
a control housing connected to and located adjacent to the pressure pad and responsive to the signal; and
a casing at least partly encasing the control housing and the pressure pad.

10. Apparatus for monitoring a patient in accordance with claim 9 in which the pressure pad is activated by removal of pressure and inactivated by application of pressure.

11. Apparatus in accordance with claim 9 further including a recorded voice message sounding within hearing distance of the patient.

12. Apparatus in accordance with claim 9 wherein the pressure pad responds to pressure by reducing electrical resistance between a first point and a second point, said apparatus including a switch armed upon the reduction of electrical resistance and an alarm for providing the alarm when the switch has been armed and the electrical resistance is under a predetermined resistance threshold for more than 1 second, wherein a movement of the patient from the pressure pad triggers the alarm.

13. A patient monitoring system according to claim 9 in which the alarm provides the alarm when the switch has been armed and electrical resistance is under the predetermined resistance threshold for a time between 2 seconds and 3 seconds in duration.

14. A method of monitoring a patient, comprising the steps of:
placing a pressure pad that is encased in a cover on a resting place for the patient;
energizing the pressure pad, whereby a signal is provided responsive to pressure placed on the pressure pad by the patient;
arming the pressure pad when a predetermined weight is on the pressure pad whereby the pressure pad serves as a sensor;
said step of arming the pressure pad including the step of placing sufficient pressure on the pressure pad to close first and second contacts of a pressure sensor in said pressure pad;
said step of closing said first and second contacts including the step of bending one of said first and second contacts over a spacing means, wherein the spacing means includes at least one spacing member that is at least one-eighth inch in height between the first and second contacts, whereby the contacts are held apart until the resilient spacing member is forced shut;
activating an alarm when the predetermined weight is removed from the armed pressure pad; and
disposing of the pressure pad when the patient no longer has use of the pressure pad.

15. A method in accordance with claim 14 wherein the alarm is provided to a caretaker.

16. A method in accordance with claim 14 wherein the alarm is near the patient.

17. A method in accordance with claim 14 wherein the alarm is at a remote station.

18. A method of monitoring a patient in accordance with claim 14 wherein the cover is plastic and is torn when the pressure pad is to be disposed of.
